(19) United States
(12) Patent Application Publication
(10) Pub. No.: US 2024/0379948 A1
(43) Pub. Date: Nov. 14, 2024

(54) ANODE ACTIVE MATERIAL FOR LITHIUM SECONDARY BATTERY, METHOD OF PRODUCING SAME, AND LITHIUM SECONDARY BATTERY INCLUDING SAME

(71) Applicant: KANGWON NATIONAL UNIVERSITY INDUSTRY COOPERATION FOUNDATION, Chuncheon-si (KR)

(72) Inventors: Sung Man LEE, Hanam-si (KR); Yoon Sang NOH, Sejong (KR)

(73) Assignee: KANGWON NATIONAL UNIVERSITY INDUSTRY COOPERATION FOUNDATION, Chuncheon-si (KR)

(21) Appl. No.: 18/782,318

(22) Filed: Jul. 24, 2024

Related U.S. Application Data
(63) Continuation of application No. PCT/KR2022/012840, filed on Aug. 26, 2022.

(30) Foreign Application Priority Data
Feb. 9, 2022 (KR) 10-2022-0016882

(51) Int. Cl. H01M 4/36; C01B 32/21; H01M 4/02; H01M 4/587; H01M 10/0525

(52) U.S. Cl. CPC H01M 4/366; C01B 32/21; H01M 4/587; H01M 10/0525; C01P 2002/85; C01P 2004/03; C01P 2004/32; C01P 2004/50; C01P 2006/40; H01M 2004/027

(57) ABSTRACT

Provided are an anode active material for a lithium secondary battery including spheronized natural graphite particles. The spheronized natural graphite particles have a structure in which flaky natural graphite fragment particles are agglomerated and granulated into a cabbage shape or random shape, phosphorus (P) atoms are bonded to edge planes of all or some of the flaky natural graphite fragment particles that constitute the interior or surface of the spheronized natural graphite particles, and an amorphous and/or low-crystallinity carbon coating layer is formed on the edge planes and basal planes of all or some of the flaky natural graphite fragment particles, a method of producing the same, and a lithium secondary battery including the same.

### CROSS-REFERENCE TO RELATED APPLICATIONS

This application is continuation of International Application No. PCT/KR2022/012840 filed on Aug. 26, 2022, which claims priority to Korean Application No. 10-2022-0016882 filed on Feb. 9, 2022, the entire contents of which are herein incorporated by reference.

### TECHNICAL FIELD

The present disclosure relates to an anode active material for a lithium secondary battery, a method of producing the same, and a lithium secondary battery including the anode active material for a lithium secondary battery.

### BACKGROUND

The demand for lithium secondary batteries is growing rapidly as an energy source for not only mobile devices but also electric vehicles and the like, and there is a need to improve the performance of stability and long life characteristics at high temperatures of lithium secondary batteries in relation to the expansion of these applications.

Currently, crystalline graphite materials are used as anode active materials for lithium secondary batteries, and crystalline graphite is divided into artificial graphite and natural graphite. Artificial graphite is relatively superior in life characteristics, swelling characteristics, and the like at high temperatures compared to natural graphite, and thus its use is increasing. However, because artificial graphite is typically obtained through processes of heating and carbonizing a carbon precursor at a high temperature of about 2800° C. or higher in an inert atmosphere, removing impurities, and graphitizing it, there are problems that the manufacturing cost is high, and the lithium storage capacity is somewhat smaller than that of natural graphite due to the limited degree of graphitization.

Currently commercialized natural graphite is used by agglomerating flaky natural graphite fragments into cabbage shapes or random shapes, granulating them into spheres, and then coating the surface with amorphous carbon.

However, in the case of spheronized natural graphite coated with carbon, the carbon-coated layer on the surface undergoes side reactions with the electrolyte inside the spherical graphite particles due to the occurrence of mechanical cracks during repeated charge/discharge cycles, resulting in an SEI film being further formed (which is commonly referred to as internal SEI). Due to gas generation and swelling phenomena caused by these side reactions, the problem of a high-temperature life degradation phenomenon and high-temperature life characteristics and output characteristics have been found to be insufficient for application to electric vehicles, etc., and thus, further performance improvement is needed.

The side reactions are caused by electrolyte decomposition reactions on the surface of the graphite particles, and in particular, edge sites, which are active sites of the graphite particles, are known to further accelerate the electrolyte decomposition reactions. Accordingly, it is necessary to develop technology to solve the problems caused by side reactions with the electrolyte and improve structural stability through surface stabilization of flaky natural graphite fragment particles that make up the surface and interior of spheronized natural graphite.

### SUMMARY

### Technical Objects

One implementation of the present disclosure is intended to provide an anode active material for a lithium secondary battery with improved stability at high temperatures and excellent cycle characteristics at high temperatures and room temperature.

Another implementation of the present disclosure is intended to provide a method of producing an anode active material for a lithium secondary battery.

Yet another implementation of the present disclosure is intended to provide a lithium secondary battery including the anode active material for a lithium secondary battery.

### Technical Solution

In order to achieve the objects above, the present disclosure provides an anode active material for a lithium secondary battery including spheronized natural graphite particles, characterized in that the spheronized natural graphite particles have a structure in which flaky natural graphite fragment particles are agglomerated and granulated into a cabbage shape or random shape, phosphorus (P) atoms are bonded to edge planes of all or some of the flaky natural graphite fragment particles, and an amorphous or low-crystallinity carbon coating layer is formed on the edge planes and basal planes of all or some of the flaky natural graphite fragment particles.

One implementation of the anode active material in accordance with the present disclosure may be an anode active material for a lithium secondary battery including spheronized natural graphite particles, characterized in that edge planes of all or at least some of flaky natural graphite fragment particles that constitute the surface and interior of the spheronized natural graphite particles are selectively adsorbed by a phosphorus compound and then surface-modified through heat treatment, resulting in C—O—P or C—P—O bonds being formed on the surface of the edge planes, and further, an amorphous or low-crystallinity carbon coating layer is formed on the edge planes and basal planes of all or some of the flaky natural graphite fragment particles.

The total amount of amorphous or low-crystallinity carbon formed on the edge planes and the basal planes of all or some of the flaky natural graphite fragment particles may be 3 to 10 wt % based on the total amount of the anode active material.

In this case, said amorphous or low-crystallinity carbon may be formed from a carbon precursor including at least one selected from gum arabic, citric acid, stearic acid, sucrose, vinylidene difluoride, carboxymethyl cellulose (CMC), hydroxypropyl cellulose, regenerated cellulose, polyvinylpyrrolidone, tetrafluoroethylene, polyethylene, polypropylene, ethylene-propylene-diene monomer (EPDM), sulfonated EPDM, starch, phenolic resin, furan resin, furfuryl alcohol, polyacrylic acid, sodium polyacrylate, polyacrylonitrile, polyimide, epoxy resin, cellulose, styrene, polyvinyl alcohol, polyvinyl chloride, coal pitch, petroleum pitch, mesophase pitch, low molecular weight heavy oil, glucose, gelatin, and saccharides.

Further, the present disclosure in another aspect of the disclosure provides a method of producing an anode active material for a lithium secondary battery, including the steps of (a) preparing a solution containing flaky natural graphite fragment particles, a phosphorus compound, and a solvent, (b) selectively adsorbing the phosphorus compound onto edge planes of all or at least some of the flaky natural graphite fragment particles by stirring the solution, (c) producing modified flaky natural graphite fragment particles by drying and heat-treating the solution, (d) coating the modified flaky natural graphite fragment particles with an amorphous or low-crystallinity carbon precursor, (c) obtaining a spheronized natural graphite composite particle precursor by agglomerating and granulating the modified flaky natural graphite fragment particles coated with the amorphous or low-crystallinity carbon precursor into a cabbage shape or random shape, and (f) heat-treating the spheronized natural graphite composite particle precursor, as a method of producing the anode active material.

In this case, the phosphorus compound is characterized by being one or more selected from the group consisting of tricresyl phosphate (TCP), tributyl phosphate (TBP), triphenyl phosphate (TPP), triethyl phosphate (TEP), trioctyl phosphate, tritolyl phosphite, and tri-isooctylphosphite.

The solution produced in said step (a) is characterized by including 100 parts by weight of the flaky natural graphite fragment particles and 0.00001 to 5 parts by weight of the phosphorus compound.

In addition, the solution produced in said step (a) may include a solvent selected from the group consisting of water, ethanol, acetone, methanol, and isopropanol.

Moreover, the drying process in said step (c) may be performed in at least one spray drying method selected from rotary spraying, nozzle spraying, and ultrasonic spraying, a drying method using a rotary evaporator, a vacuum drying method, or a natural drying method.

Furthermore, the heat treatment process in said step (c) may be performed in an atmosphere containing air or oxygen, in an atmosphere containing nitrogen, argon, hydrogen, or a mixed gas thereof, or under a vacuum.

Meanwhile, the heat treatment process in said step (c) may be performed at a temperature of 200 to 2000° C. if performed in the atmosphere containing nitrogen, argon, hydrogen, or a mixed gas thereof, or under a vacuum, or may be performed at a temperature of 200 to 600° C. if performed in the atmosphere containing air or oxygen.

In addition, the process of coating the modified flaky natural graphite fragment particles with the amorphous or low-crystallinity carbon precursor in said step (d) may be performed by a dry method or a wet method.

Further, the heat treatment process in said step (f) may be performed at a temperature of 600 to 2000° C. in an atmosphere containing nitrogen, argon, hydrogen, or a mixed gas thereof, or under a vacuum.

Moreover, the present disclosure provides a method of producing an anode active material for a lithium secondary battery, including the steps of (a) preparing a solution containing flaky natural graphite fragment particles, a phosphorus compound, and a solvent, (b) selectively adsorbing the phosphorus compound onto edge planes of all or at least some of the flaky natural graphite fragment particles by stirring the solution, (c) coating the flaky natural graphite fragment particles, onto which the phosphorus compound has been selectively adsorbed, with an amorphous or low-crystallinity carbon precursor after drying the solution, (d) obtaining a spheronized natural graphite composite particle precursor by agglomerating and granulating the flaky natural graphite fragment particles coated with the amorphous and low-crystallinity carbon precursor into a cabbage shape or random shape, and (c) heat-treating the spheronized natural graphite composite particle precursor, as another example of a method of producing the anode active material.

In this case, the phosphorus compound is characterized by being one or more selected from the group consisting of tricresyl phosphate (TCP), tributyl phosphate (TBP), triphenyl phosphate (TPP), triethyl phosphate (TEP), trioctyl phosphate, tritolyl phosphite, and tri-isooctylphosphite.

The solution produced in said step (a) is characterized by including 100 parts by weight of the flaky natural graphite fragment particles and 0.00001 to 5 parts by weight of the phosphorus compound.

In addition, the solution produced in said step (a) may include a solvent selected from the group consisting of water, ethanol, acetone, methanol, and isopropanol.

Moreover, the drying process in said step (c) may be performed in at least one spray drying method selected from rotary spraying, nozzle spraying, and ultrasonic spraying, a drying method using a rotary evaporator, a vacuum drying method, or a natural drying method.

Further, the process of coating the flaky graphite fragment particles, in which the phosphorus compound has been selectively adsorbed onto the edge planes, with the amorphous or low-crystallinity carbon precursor in said step (c) may be performed by a dry method or a wet method.

Furthermore, the heat treatment process in said step (c) may be performed at a temperature of 600 to 2000° C. in an atmosphere containing nitrogen, argon, hydrogen, or a mixed gas thereof, or under a vacuum.

In yet another aspect of the disclosure, the present disclosure provides a lithium secondary battery including an anode including the anode active material, a cathode, and an electrolyte.

Specific details of other implementations of the present disclosure are included in the detailed description below.

### Effects of the Disclosure

The anode active material for a lithium secondary battery in accordance with the present disclosure can enable the realization of a lithium secondary battery with improved stability at high temperatures and excellent cycle characteristics at high temperatures and room temperature.

### BRIEF DESCRIPTION OF THE DRAWINGS

FIGS. 1(a) and 1(b) are the results of XPS analysis of a sample of highly oriented pyrolytic graphite produced according to Experimental Example 1 of the present disclosure;

FIG. 2 is a scanning electron microscope (SEM) photograph of an anode active material in accordance with Embodiment 1;

FIG. 3 is a scanning electron microscope (SEM) photograph of an anode active material in accordance with Comparative Example 1;

FIG. 4 is a scanning electron microscope (SEM) photograph of an anode active material in accordance with Comparative Example 2; and

FIG. 5 shows changes in the capacity retention rate of the anode active materials in accordance with Embodiment 1 and Comparative Examples 1 and 2, respectively, with the progress of charge/discharge cycles at 45° C.

### DETAILED DESCRIPTION

In describing the present disclosure, if it is determined that specific descriptions of related known functions or configurations may unnecessarily obscure the subject matter of the present disclosure, the detailed description will be omitted.

Since the embodiments in accordance with the concepts of the present disclosure can be subject to various modifications and have many forms, certain embodiments will be illustrated in the drawings and described in detail in the present specification or application. However, it should be understood that this is not intended to limit the embodiments in accordance with the concepts of the present disclosure to particular forms disclosed, but to include all modifications, equivalents, and alternatives that fall within the spirit and scope of the present disclosure.

The terms used herein are merely used to describe particular embodiments and are not intended to limit the present disclosure. Singular expressions include plural expressions unless the context clearly indicates otherwise. In this specification, it should be understood that the terms such as “include” or “have” are intended to specify the presence of the described features, numbers, steps, operations, components, parts, or combinations thereof, and not to preclude the possibility of the presence or addition of one or more other features, numbers, steps, operations, components, parts, or combinations thereof.

Hereinafter, the present disclosure will be described in detail.

An anode active material for a lithium secondary battery in accordance with the present disclosure includes spheronized natural graphite particles, and characterized in that the spheronized natural graphite particles have a structure in which flaky natural graphite fragment particles are agglomerated and granulated in a cabbage shape or random shape, phosphorus (P) atoms are bonded to the edge planes of all or at least some of the flaky natural graphite fragment particles that constitute the interior or surface of the spheronized natural graphite particles, and an amorphous and/or low-crystallinity carbon coating layer is formed on the edge planes and/or basal planes of all or some of the flaky natural graphite fragment particles.

When the spheronized natural graphite particles in accordance with one implementation are as described above, in which the edge planes of all or at least some particles of the flaky natural graphite fragments present on the surface and interior of the spheronized natural graphite particles are selectively adsorbed by a phosphorus compound and then are surface-modified through heat treatment, and furthermore, an amorphous and/or low-crystallinity carbon coating layer is formed on the edge planes and/or basal planes of all or some of the flaky natural graphite fragment particles, the stability of the surface structure of the edge planes of the flaky natural graphite fragments can be ensured, the reactivity with the electrolyte can be improved, and lithium ion diffusion and electrical conductivity within the spheronized natural graphite particles can be improved, thereby making it possible to realize a lithium secondary battery with excellent charge/discharge characteristics and cycle life characteristics at room temperature and high temperatures.

Specifically, an exfoliation phenomenon of graphite by the side reactions with the electrolyte does not occur on the edge planes of the flaky natural graphite fragments present on the surface or interior of the spheronized natural graphite particles even if repetitive charging and discharging are performed at room temperature and high temperatures as the surface stability of the edge planes of the flaky natural graphite fragments present on the surface and interior of the spheronized natural graphite particles is ensured, the structural stability of the spheronized natural graphite particles is improved as they are coated with the amorphous and/or low-crystallinity carbon and are spherically granulated, the spheronized graphite particles are easily compressed even when rolling them to produce high-density electrodes, and the flaky graphite fragment particles are oriented parallel to the current collector, and thus, it is possible to prevent the problem that battery performance is degraded significantly due to clogging of the pores in the electrode.

The total amount of amorphous and/or low-crystallinity carbon coated on the edge planes and basal planes of all or some of the flaky natural graphite fragment particles may be 3 to 10 wt %, more preferably 3 to 7 wt %, based on the total amount of the anode active material. If the amorphous and/or low-crystallinity carbon is included within the above range, coating and spheronized granulation by amorphous and/or low-crystallinity carbon is achieved effectively, thereby exhibiting excellent characteristics as an anode active material.

Meanwhile, the average particle diameter (D50) of the spheronized natural graphite particles may be 5 to 40 μm.

The anode active material in accordance with the present disclosure described above can be produced by the following method.

One example of a method for producing the anode active material may include the steps of (a) preparing a solution containing flaky natural graphite fragment particles, a phosphorus compound, and a solvent, (b) selectively adsorbing the phosphorus compound onto the edge planes of all or at least some of the flaky natural graphite fragment particles by stirring the solution, (c) producing modified flaky natural graphite fragment particles by drying and heat-treating the solution, (d) coating the modified flaky natural graphite fragment particles with an amorphous or low-crystallinity carbon precursor, (e) obtaining a spheronized natural graphite composite particle precursor by agglomerating and granulating the modified flaky natural graphite fragment particles coated with the amorphous and low-crystallinity carbon precursor into a cabbage shape or random shape, and (f) heat-treating the spheronized natural graphite composite particle precursor.

In this case, the phosphorus compound may be one or more selected from the group consisting of tricresyl phosphate (TCP), tributyl phosphate (TBP), triphenyl phosphate (TPP), triethyl phosphate (TEP), trioctyl phosphate, tritolyl phosphite, and tri-isooctylphosphite.

Further, the solution produced in said step (a) may include 100 parts by weight of the flaky natural graphite fragment particles and 0.00001 to 5 parts by weight of the phosphorus compound.

In addition, the solution produced in said step (a) may include a solvent selected from the group consisting of water, ethanol, acetone, methanol, and isopropanol.

Furthermore, the drying process in said step (c) may be performed in at least one spray drying method selected from rotary spraying, nozzle spraying, and ultrasonic spraying, a drying method using a rotary evaporator, a vacuum drying method, or a natural drying method.

Moreover, the heat treatment process in said step (c) may be performed in an atmosphere containing air or oxygen, in an atmosphere containing nitrogen, argon, hydrogen, or a mixed gas thereof, or under a vacuum.

Meanwhile, the heat treatment process in said step (c) may be performed at a temperature of 200 to 2000° C. if performed in the atmosphere containing nitrogen, argon, hydrogen, or a mixed gas thereof, or under a vacuum, or may be performed at a temperature of 200 to 600° C. if performed in the atmosphere containing air or oxygen.

In said step (d), the process of coating the modified flaky graphite fragment particles with the amorphous and low-crystallinity carbon precursor may be performed by a dry method or a wet method.

Further, the heat treatment process in said step (f) may be performed at a temperature of 600 to 2000° C. in an atmosphere containing nitrogen, argon, hydrogen, or a mixed gas thereof, or under a vacuum.

Another example of a method for producing the anode active material in accordance with the present disclosure may include the steps of (a) preparing a solution containing flaky natural graphite fragment particles, a phosphorus compound, and a solvent, (b) selectively adsorbing the phosphorus compound onto the edge planes of all or at least some of the flaky natural graphite fragment particles by stirring the solution, (c) coating the flaky natural graphite fragment particles, onto which the phosphorus compound has been selectively adsorbed, with an amorphous or low-crystallinity carbon precursor after drying the solution, (d) obtaining a spheronized natural graphite composite particle precursor by agglomerating and granulating the flaky natural graphite fragment particles coated with the amorphous and low-crystallinity carbon precursor into a cabbage shape or random shape, and (c) heat-treating the spheronized natural graphite composite particle precursor.

In this case, the phosphorus compound is characterized by being one or more selected from the group consisting of tricresyl phosphate (TCP), tributyl phosphate (TBP), triphenyl phosphate (TPP), triethyl phosphate (TEP), trioctyl phosphate, tritolyl phosphite, and tri-isooctylphosphite.

The solution produced in said step (a) is characterized by including 100 parts by weight of the flaky natural graphite fragment particles and 0.00001 to 5 parts by weight of the phosphorus compound.

Further, the solution produced in said step (a) may include a solvent selected from the group consisting of water, ethanol, acetone, methanol, and isopropanol.

Moreover, the drying process in said step (c) may be performed in at least one spray drying method selected from rotary spraying, nozzle spraying, and ultrasonic spraying, a drying method using a rotary evaporator, a vacuum drying method, or a natural drying method.

In said step (c), the process of coating the flaky graphite fragment particles, in which the phosphorus compound has been selectively adsorbed onto the edge planes, with the amorphous and low-crystallinity carbon precursor may be performed by a dry method or a wet method.

Furthermore, the heat treatment process in said step (e) may be performed at a temperature of 600 to 2000° C. in an atmosphere containing nitrogen, argon, hydrogen, or a mixed gas thereof, or under a vacuum.

If the spheronized natural graphite particles produced as described above are used as an anode active material, the surface stability of the edge planes of the flaky natural graphite fragments present on the surface or interior of the spheronized natural graphite particles can be ensured, thereby suppressing side reactions with the electrolyte during charging and discharging. In addition, by having the flaky natural graphite fragments that constitute the spheronized natural graphite particles further coated with amorphous and/or low-crystallinity carbon, the structural stability of the spheronized natural graphite particles can be ensured, enabling the production of high-density electrodes, and lithium ion diffusion and electrical conductivity within the spheronized natural graphite particles can be improved, thereby making it possible to realize a lithium secondary battery with excellent cycle life characteristics at room temperature and high temperatures.

According to another implementation, a lithium secondary battery including an anode including the anode active material described above, a cathode, and an electrolyte is provided.

The lithium secondary battery can be classified into a lithium ion battery, a lithium ion polymer battery, and a lithium polymer battery according to the type of separator and electrolyte used, can be classified into a cylindrical type, a prismatic type, a coin type, a pouch type, etc., according to the shape, and can be divided into a bulk type and a thin film type according to the size. The structures and production methods of these batteries are widely known in the field and accordingly, detailed descriptions will be omitted.

The anode can be produced by mixing the anode active material described above, a binder, and optionally, a conductive material to produce a composition for forming an anode active material layer and then applying it to the anode current collector, and since these anode configurations are widely known in the field, detailed descriptions will be omitted.

### Modes for Carrying Out the Disclosure

In the following, the present specification will be described in detail by way of embodiments. However, embodiments in accordance with the present specification may be modified into various other forms, and the scope of the present specification is not to be construed as being limited to the embodiments described in detail below. The embodiments of the present specification are provided to more completely describe the present specification to those having ordinary knowledge in the art.

### Embodiment 1

First, 100 parts by weight of flaky natural graphite particles (POSCO Chemical Co.) with an average particle diameter (D50) of 20 μm and 0.05 parts by weight of tricresyl phosphate (TCP) were added to ethanol, stirred for 30 minutes, and then dried, and next, the flaky natural graphite particles to which tricresyl phosphate was adsorbed were coated with petroleum pitch and then granulated into spheres using a granulator. The granulated particles were heat-treated at 1000° C. in a nitrogen atmosphere for 1 hour, thereby producing an anode active material with an average particle diameter (D50) of 15.7 μm. The residual carbon content of the petroleum pitch after the heat treatment is 5 wt % based on the anode active material.

### Comparative Example 1

Flaky natural graphite particles (POSCO Chemical Co.) with an average particle diameter (D50) of 20 μm were coated with petroleum pitch and then granulated into spheres using a granulator. The granulated particles were heat-treated at 1200° C. in a nitrogen atmosphere for 1 hour, thereby producing an anode active material with an average particle diameter (D50) of 15.6 μm. The residual carbon content of the petroleum pitch after the heat treatment is 5 wt % based on the anode active material.

### Comparative Example 2

One obtained by coating amorphous carbon on the surface of spheronized natural graphite particles with an average particle diameter (D50) of 17 μm, which was provided by POSCO Chemical Co., Ltd., was used as an anode active material.

### Experimental Example 1

A sample of highly oriented pyrolytic graphite and 5 wt % of tricresyl phosphate (TCP) based on the highly oriented pyrolytic graphite were added to ethanol, stirred for 30 minutes at room temperature, and then dried, and next, were heat-treated at 300° C. and 400° C. for 1 hour in an air atmosphere.

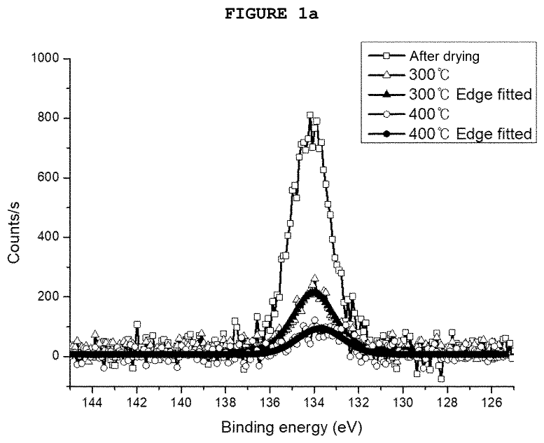

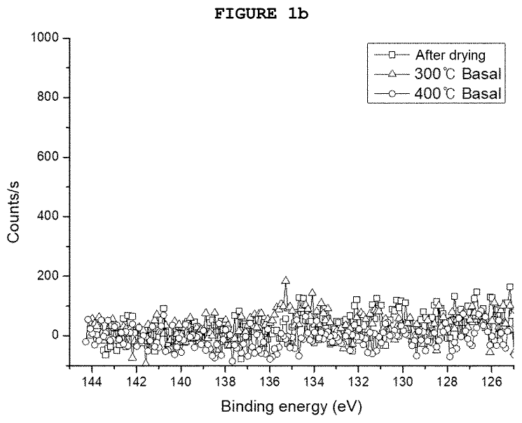

FIG. 1 shows the results of X-ray photoelectron spectroscopy (XPS) analysis of highly oriented pyrolytic graphite produced according to Experimental Example 1, and shows that bonds associated with the phosphorus (P) element were formed on the edge planes as shown in FIG. 1a but no bonds associated with the phosphorus (P) element were formed on the basal planes (FIG. 1b) when the sample of highly oriented pyrolytic graphite was adsorbed with tricresyl phosphate (TCP) and then was heat-treated at 300° C. and 400° C. for 1 hour in an air atmosphere. As a result, it can be seen that the phosphorus compound of the present disclosure is selectively adsorbed on the edge planes of the artificial graphite, and that the phosphorus compound adsorbed on the edge planes after drying is decomposed and thus, the bonds associated with the phosphorus (P) element decrease, as the temperature of the subsequent heat treatment increases. The P element located on the edge planes of the graphite surface is shown to form a C—P—O or C—O—P bond.

### Analysis of Scanning Electron Microscope (SEM) Photographs

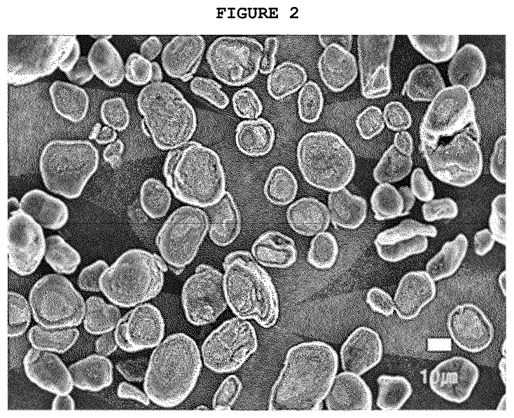

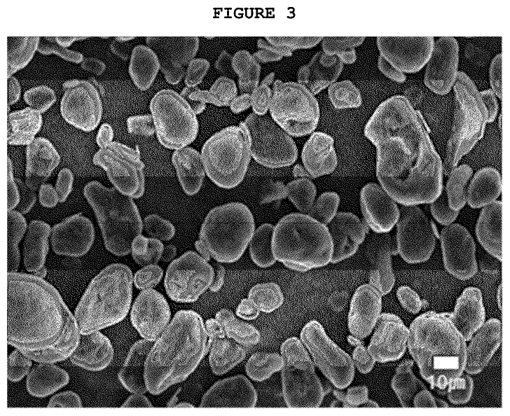

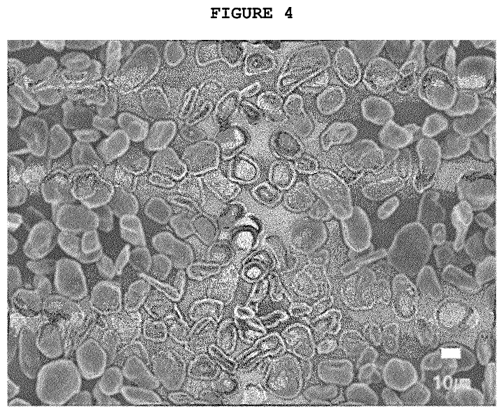

FIG. 2 is a scanning electron microscope (SEM) photograph of the anode active material in accordance with Embodiment 1, FIG. 3 is a scanning electron microscope (SEM) photograph of the anode active material in accordance with Comparative Example 1, and FIG. 4 is a scanning electron microscope (SEM) photograph of the anode active material in accordance with Comparative Example 2.

Referring to the SEM photographs in FIGS. 2 to 4, each anode active material can be seen as being granulated into a sphere and shows a nearly similar surface morphology.

### Production of Testing Cell

An anode slurry was produced by mixing each anode active material produced, respectively, in Embodiment 1 and Comparative Examples 1 and 2 above with CMC/SBR (carboxymethyl cellulose/styrene-butadiene rubber) in distilled water at a weight ratio of 96:4. The anode slurry was coated on copper foil, and then dried and pressed, thereby producing each anode.

An electrode assembly was produced by using the anode and lithium metal as the cathode and stacking them with a cell guard, which is a separator, between the anode and the cathode. Thereafter, a testing cell (2032-type coin cell) was fabricated by adding an electrolyte obtained by dissolving 0.5% of VC and IM of LiPF₆ in a mixed solvent of ethylene carbonate (EC) and ethyl methyl carbonate (EMC) (EC:EMC=2:8).

### Analysis of Charging/Discharging Characteristics

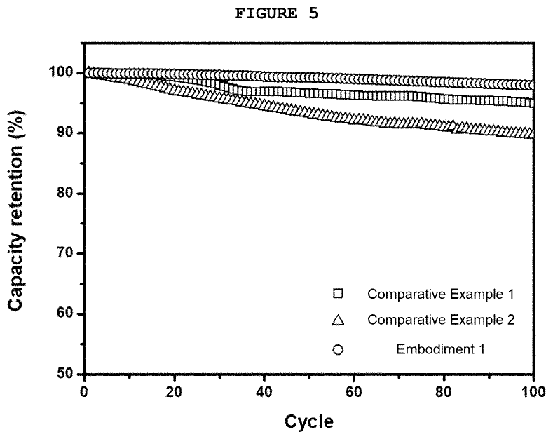

Charge/discharge life characteristics were evaluated at 45° C. in the following manner using the testing cell produced as above. The results are shown in Table 1 and FIG. 5 below, respectively.

The evaluation of charge and discharge cycle characteristics was conducted after proceeding with a formation process for 3 cycles at room temperature, charging was performed in CC/CV mode at a rate of 0.5 C, the termination voltage was maintained at 0.005 V, discharging was performed in CC mode at a rate of 0.5 C, and the termination voltage was maintained at 1.5 V.

TABLE 1

| | | Initial | |
|---|---|---|---|
| | Initial | discharge | Capacity retention rate |
| | efficiency | capacity | after 100 cycles, @ 45° C. |
| | (%) | (mAh/g) | (%) |
| Embodiment 1 | 92 | 361.3 | 97.9 |
| Comparative | 92.1 | 361.4 | 95 |
| Example 1 | | | |
| Comparative | 92.7 | 360.5 | 89.7 |
| Example 2 | | | |

Referring to Table 1 and FIG. 5, in the case of Embodiment 1, the initial efficiency and initial discharge capacity are similar to those of Comparative Examples 1 and 2, but the capacity retention rate after 100 cycles at 45° C. is shown higher. In particular, it can be seen that it shows excellent life characteristics compared to Comparative Example 2, which is currently used as a commercial product. In addition, the fact that Embodiment 1 in which flaky natural graphite fragment particles were modified with a phosphorus compound, coated with amorphous or low-crystallinity carbon, and granulated into spheres shows better life characteristics at high temperatures compared to Comparative Example 1 in which flaky natural graphite fragments were coated with carbon and granulated indicates that side reactions to the electrolyte at high temperatures are suppressed more effectively by surface-modifying the edge planes of all or at least some of the flaky natural graphite fragment particles with a phosphorus compound.

The present disclosure is not limited to the embodiments above but can be produced in various different forms, and those having ordinary skill in the art to which the present disclosure pertains will be able to understand that the present disclosure can be implemented in other specific forms without changing the technical idea or essential features thereof. Therefore, the embodiments described above should be understood as illustrative and not limiting in all respects.

### INDUSTRIAL APPLICABILITY

The anode active material for a lithium secondary battery in accordance with the present disclosure can enable the realization of a lithium secondary battery with improved stability at high temperatures and excellent cycle characteristics at high temperatures and room temperature.

What is claimed is:

1. An anode active material for a lithium secondary battery comprising spheronized natural graphite particles,
wherein the spheronized natural graphite particles have a structure in which flaky natural graphite fragment particles are agglomerated and granulated into a cabbage shape or random shape,
phosphorus (P) atoms are bonded to edge planes of all or some of the flaky natural graphite fragment particles, and
an amorphous or low-crystallinity carbon coating layer is formed on the edge planes and basal planes of all or some of the flaky natural graphite fragment particles.

2. The anode active material for a lithium secondary battery of claim 1, wherein phosphorus (P) atoms are bonded only to a surface of an edge plane, and not a basal plane, of a flaky natural graphite fragment particle.

3. The anode active material for a lithium secondary battery of claim 1, wherein phosphorus (P) atoms are bonded to a surface of an edge plane of a flaky natural graphite fragment particle in the form of C—O—P or C—P—O.

4. The anode active material for a lithium secondary battery of claim 1, wherein a content of the amorphous or low-crystallinity carbon coating layer formed on the edge planes and the basal planes of all or some of the flaky natural graphite fragment particles is 3 to 10 wt % based on a total weight of the anode active material.

5. The anode active material for a lithium secondary battery of claim 1, wherein the amorphous or low-crystallinity carbon coating layer is formed from a carbon precursor comprising at least one selected from gum arabic, citric acid, stearic acid, sucrose, vinylidene difluoride, carboxymethyl cellulose (CMC), hydroxypropyl cellulose, regenerated cellulose, polyvinylpyrrolidone, tetrafluoroethylene, polyethylene, polypropylene, ethylene-propylene-diene monomer (EPDM), sulfonated EPDM, starch, phenolic resin, furan resin, furfuryl alcohol, polyacrylic acid, sodium polyacrylate, polyacrylonitrile, polyimide, epoxy resin, cellulose, styrene, polyvinyl alcohol, polyvinyl chloride, coal pitch, petroleum pitch, mesophase pitch, low molecular weight heavy oil, glucose, gelatin, and saccharides.

6. A method of producing an anode active material for a lithium secondary battery, comprising the steps of:
(a) preparing a solution containing flaky natural graphite fragment particles, a phosphorus compound, and a solvent;
(b) selectively adsorbing the phosphorus compound onto edge planes of all or at least some of the flaky natural graphite fragment particles by stirring the solution;
(c) producing modified flaky natural graphite fragment particles by drying the solution and then heat-treating;
(d) coating the modified flaky natural graphite fragment particles with an amorphous or low-crystallinity carbon precursor;
(e) obtaining a spheronized natural graphite composite particle precursor by agglomerating and granulating the modified flaky natural graphite fragment particles coated with the amorphous or low-crystallinity carbon precursor into a cabbage shape or random shape; and
(f) heat-treating the spheronized natural graphite composite particle precursor.

7. A method of producing an anode active material for a lithium secondary battery, comprising the steps of:
(a) preparing a solution containing flaky natural graphite fragment particles, a phosphorus compound, and a solvent;
(b) selectively adsorbing the phosphorus compound onto edge planes of all or at least some of the flaky natural graphite fragment particles by stirring the solution;
(c) coating the flaky natural graphite fragment particles, onto which the phosphorus compound has been selectively adsorbed, with an amorphous or low-crystallinity carbon precursor after drying the solution;
(d) obtaining a spheronized natural graphite composite particle precursor by agglomerating and granulating the flaky natural graphite fragment particles coated with the amorphous or low-crystallinity carbon precursor into a cabbage shape or random shape; and
(e) heat-treating the spheronized natural graphite composite particle precursor.

8. The method of claim 6, wherein the phosphorus compound is one or more selected from the group consisting of tricresyl phosphate (TCP), tributyl phosphate (TBP), triphenyl phosphate (TPP), triethyl phosphate (TEP), trioctyl phosphate, tritolyl phosphite, and tri-isooctylphosphite.

9. The method of claim 6, wherein in said step (a), the solution contains 100 parts by weight of the flaky natural graphite fragment particles and 0.00001 to 5 parts by weight of the phosphorus compound.

10. The method of claim 6, wherein the solvent is selected from the group consisting of water, ethanol, acetone, methanol, and isopropanol.

11. The method of claim 6, wherein heat treatment in said step (c) is performed at a temperature of 200 to 2000° C. in an atmosphere containing nitrogen, argon, hydrogen, or a mixed gas thereof or under a vacuum, or at a temperature of 200 to 600° C. in an atmosphere containing air or oxygen, and
heat treatment in said step (f) is performed at a temperature of 600 to 2000° C. in an atmosphere containing nitrogen, argon, hydrogen, or a mixed gas thereof or under a vacuum.

12. The method of claim 7, wherein heat treatment in said step (e) is performed at a temperature of 600 to 2000° C. in an atmosphere containing nitrogen, argon, hydrogen, or a mixed gas thereof or under a vacuum.

13. A lithium secondary battery comprising:
an anode including the anode active material of claim 1;
a cathode; and
an electrolyte.
